(19) United States
(12) Patent Application Publication
(10) Pub. No.: US 2014/0279234 A1
(43) Pub. Date: Sep. 18, 2014

(54) Generation to Generation Data Storage and Access

(71) Applicant: Jason E. Barkeloo, Cincinnati, OH (US)

(72) Inventor: Jason E. Barkeloo, Cincinnati, OH (US)

(21) Appl. No.: 14/215,738

(22) Filed: Mar. 17, 2014

Related U.S. Application Data
(60) Provisional application No. 61/799,628, filed on Mar. 15, 2013.

(51) Int. Cl. G06Q 30/06

(52) U.S. Cl. CPC G06Q 30/0601; G06Q 30/0613
USPC 705/26.41; 705/26.1

(57) ABSTRACT

This disclosure is drawn to systems, devices, apparatus, methods and/or a structure of interoperating functions related to storing and accessing information among generations of users. Specifically, the disclosure relates to generating revenue from storing and accessing information among generations of users, including individuals, entities, and/or organizations. A generation-to-generation transaction model may incentivize the collection of content, genetics, knowledge, and insights, and the distribution of such collected information to future generations that would ordinarily be lost at death (of a human) or evolution (of an entity). This collection of information may be accessed and/or mined by third parties, which may present monetization opportunities that may compensate the information owner's and his related future generations. Monetization opportunities may be negotiated with the third parties by the generation-to-generation transaction system, which may act on behalf of the users.

### CROSS-REFERENCE TO RELATED APPLICATIONS

This application claims priority to U.S. Provisional Patent Application Ser. No. 61/799,628, filed on Mar. 15, 2013, the contents of which are incorporated herein by reference in their entirety.

### BACKGROUND

When a human life is lost, the genetic information, knowledge, and insights known by that person, and comprise that person, are generally lost forever. At death, the book that is that person is lost to the world forever.

Similarly, as organizations such as companies fail, decline, evolve or grow, information about the company may be lost over time. Information such as corporate history, corporate culture, and corporate legal and non-legal relationships may be important to preserve, as they are assets to the organization. Such information may be beneficial to impress upon subsidiaries, acquisitions, employees, and customers.

A mechanism to preserve these types of information may allow future entities to study, model, recreate, and/or learn from those past entities. Additionally, revenues may be realized from the storage of and access to this information.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

In the drawings:

FIG. 1 is a schematic representation of an example generation to generation data storage and access system;

FIG. 2 is a schematic representation of another example generation to generation data storage and access system;

FIG. 3 is an example generation to generation data storage and access revenue model;

FIGS. 4-5 depict example generation to generation storage and access revenue models for storage of one user's data;

FIGS. 6-7 depict example generation to generation storage and access revenue models for storage of three users' data; and

FIGS. 8-10 depict additional example generation to generation storage and access revenue models; all arranged in accordance with at least some of the embodiments disclosed in the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

A generation-to-generation transaction model may incentivize the collection and distribution of content that can provide insights into knowledge that would ordinarily be lost at death (of a human) or evolution (of an entity).

In some examples, the generation-to-generation system may provide a financial and emotional incentive to future data users to continue the maintenance and access to the original content creator's digital information assets even after the content creator ceases creating or storing content. The generation-to-generation system may simultaneously incentivize a user to also store information for future generations to access. The present disclosure contemplates that value stored in the content creator's information, genetics, knowledge, and insights may be realized by future subscribers.

In some examples, the generation-to-generation system may provide a collective negotiating environment for content creators with the content hosts. Conventional business-to-business and business-to-consumer data transaction models assign the ownership of content with the hosting providers, not the creator of the content. Content hosts conventionally use an end-user licensing agreement (EULA) to take control of the content created by its users.

The generation-to-generation system may be a functional middleware layer between the content creators and the content hosts. This middleware may be a new transaction model that enables economic and emotional incentives to the content creator providing the content. The generation-to-generation system may also provide an incentive model to continue the maintenance of access to the content creator's information assets even after the content creator ceases creating or storing content. In this way, information, content, knowledge, and insights that might otherwise be destroyed, or enforcement of EULAs, may be still be made available to future generations for realizing value.

In some examples, the present disclosure contemplates that a digital version of a person may live into the future to provide future generations insights into that person's genetics, knowledge, and experiences. The present disclosure contemplates generating revenues by supplying and incentivizing access to future generations after a physical person is no longer alive. That is, the present disclosure seeks to extend access to the lives of people beyond the end of their physical existence.

This disclosure is generally drawn to systems, devices, apparatus, and/or methods related to storing and accessing information among generations of users. Specifically, the disclosed systems, devices, apparatus, and/or methods relate to generating revenue from storing and accessing information among generations of users, including individuals, entities, and/or organizations.

The present disclosure contemplates that generation may be broadly defined to mean a period of life of an entity, the period have a defined start and a defined end. For example, a generation for humans or corporate entities may be dozens of years, while a generation for DNA may be thousands of years. In some examples, a generation may be a class of people, where the people in the class have shared experiences or shared characteristics during a time period.

The present disclosure contemplates that a user may include human and non-human entities, including companies, organizations, machines, robotic devices, chemical entities and processes, and data, for example.

Where the users are humans, example users may include familial generations of a family, which may not be limited to a biological passage of genes among generations. Example familial generations of a family may include blood relationships, marriage relationships, adoption relationships, and/or legal relationships among generations. An example legal relationship may include a will, license, and/or power of attorney. In some examples, familial generations may include a formal or informal family, including acquaintances, friends, and/or members of an organization. In some examples, family may include a class of people.

Where the users are companies or organizations, example users may include parent companies, subsidiaries, spin-offs, affiliates, boards, board members, owners, executives, departments, groups, individuals in their capacity as employees, and/or customers.

In some examples, digital assets may include information about the user, including the following examples:
accounts owned and/or controlled by the user;
profiles related to the user;
files related to the user;
audio, video, and images related to the user;
legal instruments of the user;
the identity and/or identifying information of the user;
genetic information of the user;
biometric information of the user;
Internet travel pathway (e.g., website history) of the user;
performance information (e.g., golf scores, exercise history, diet) of the user;
lifestyle information (e.g., pets, hobbies, financial habits, relationships) of the user;
and the like.
   Digital assets may include information, stored as data, that when put together may represent a unique person or entity, or characteristic(s) thereof.

These digital assets may be stored as data in databases on storage devices accessible to the user and/or other users. In some examples, these digital assets may be stored digitally, electronically, magnetically, and/or chemically. A chemical bond, for example, may include information storage capability within its bonds, proteins, and/or group of proteins.

FIG. 1 is a schematic representation of an example generation to generation data storage and access system 100, in accordance with at least some embodiments of the present disclosure. The system 100 may allow users in multiple generations to store and/or access digital assets 110 over time. This may allow users from multiple generations to access digital assets 110 stored by other users. This may also allow users to store their own digital assets 110 and allow other users to access them.

A user 121 from a first generation (i.e., Generation 1) may begin storing digital assets 110 via a portal 180. Some example portals 180 may include a website, a computing device application, an application programming interface, and the like. The portal 180 may be accessed via computing devices (e.g., computers, phones, tablets) operated by users from the various generations in the system 100. Such access may be via a network such as the Internet.

A user 141 from a second generation (i.e., Generation 2) may desire to access and/or view the digital assets 110 of user 121. User 141 may also wish to store their own digital assets 110. Similarly, a user 161 from a third generation (i.e., Generation 3) may desire to access and/or view the digital assets 110 of user 121, and may desire to store their own digital assets 110. The system 100 may allow access to the digital assets 110 by user 121 from Generation 1, user 141 from Generation 2, and user 161 from Generation 3.

In some examples, the owner and/or operator of the portal 180 may charge fee(s) for various actions associated with the digital assets 110. Some example fees may include fees for opening a user account with the portal 180, fees for creating a profile for a user account, fees for associating digital assets 110 with a user account, fees for storing the digital assets 110, fees for modifying the digital assets 110, fees for deleting the digital assets 110, fees for allowing access to the digital assets 110 by other users, fees for exporting the digital assets 110, and the like.

A simple example of such a system 100 may include familial generations including a grandfather 121 from Generation 1, the grandfather's daughter 141 from Generation 2, and the grandfather's grandson 161 from Generation 3. The grandfather 121 may create a user account through the portal 180 to store digital assets 110 associated with the grandfather 121. These digital assets 110 may include health records, family photographs, videos, website accounts, bank accounts, insurance accounts, and the like, all related to the grandfather 121. The daughter 141 may be interested in accessing the digital assets 110, as she may have an emotional and/or financial interest in the digital assets 110 of the grandfather 121. As the grandson 161 grows up, the grandson 161 may also be interested in the digital assets 110 of the grandfather 121. In example system 100, each of the grandfather 121, the daughter 141, and the grandson 161 may access the digital assets 110 through portal 180.

The grandfather 121, the daughter 141, and the grandson 161 may each have to pay a fee for access to the digital assets 110. For example, the grandfather 121 may have to pay an owner and/or operator of the portal 180 an initial fee for creating a user account capable of creating, transmitting, and storing the digital assets 110 on the portal 180. This initial fee may allow the grandfather 121 storage and access to the digital assets 110 for an initial time period (e.g., one month, one year). Upon expiration of the initial time period, the grandfather 121 may then need to pay a renewal fee for continued storage and access to the digital assets 110 for a renewal time period (e.g., one month, one year). This cycle may periodically continue until the grandfather 121 closes his user account, stops paying renewal fees, and/or becomes deceased, for example.

Similarly, the daughter 141 may have to pay the owner and/or operator of the portal 180 an initial fee for creating a user account capable of accessing the digital assets 110. This initial fee may allow the daughter 141 access to the digital assets 110 for an initial time period (e.g., one month, one year). Upon expiration of the initial time period, the daughter 141 may then need to pay a renewal fee for continued access to the digital assets 110 for a renewal time period (e.g., one month, one year). This cycle may periodically continue until the daughter 141 closes her user account, stops paying renewal fees, and/or becomes deceased, for example.

Similarly, the grandson 161 may have to pay the owner and/or operator of the portal 180 an initial fee for creating a user account capable of accessing the digital assets 110. This initial fee may allow the grandson 161 access to the digital assets 110 for an initial time period (e.g., one month, one year). Upon expiration of the initial time period, the grandson 161 may then need to pay a renewal fee for continued access to the digital assets 110 for a renewal time period (e.g., one month, one year). This cycle may periodically continue until the grandson 161 closes his user account, stops paying renewal fees, and/or becomes deceased, for example.

In general, the ties and/or relationships between generations are lessened or diminished the farther apart the generations are. For example, a user may be less likely to “unplug” and lose forever her father's digital assets because the user may have an emotional attachment to or need for the information. However, that user may not have an emotional attachment to or need for the information of her great-great-grandfather. For at least this reason, the fees for each generation may be different.

For example, the initial fees and renewal fees may be different for each of the grandfather 121, the daughter 141, and the grandson 161. The daughter 141 may have much closer emotional ties to the grandfather 121, while the grandson 161 may have a very distant relationship with the grandfather 121. Accordingly, the daughter 141 may be willing to pay relatively more for access to the digital assets 110, while the grandson 161 may be willing to pay relatively less for access to the digital assets 110. Some detailed example transaction models are discussed below in relation to FIGS. 4-7.

FIG. 2 is a schematic representation of another example generation to generation data storage and access system, in accordance with at least some embodiments of the present disclosure. Multiple generations may store and/or access digital assets associated with user(s) over time. Specifically, users from Generation 1, Generation 2, and Generation 3 may desire to store and/or access digital assets their own digital assets and may desire to access digital assets of users.

In the example of FIG. 2, Generation 1 includes one user (user 221), Generation 2 includes two users (users 241, 242), and Generation 3 includes three users (users 261, 262, 263). All users may access portal 280 via network-connected computing devices (e.g., computers, phones, tablets) that may transmit data to and may receive data from the portal 280 over a network 290 (e.g., Internet). The users may access digital assets stored as data 213-299 through the portal 280.

The digital assets may be stored as data 213-299 in database(s) 212 on storage device(s) 211. Data 213 may be stored in the database(s) 212 in any known format. Data 213-299 may be accessed separately for each user depending on what access each user pays for. For example, the user 241 may pay for access to data 213 only, while the user 263 may pay for access to data 213 and data 299.

Similar to FIG. 1, each of user 221, users 241, 242, and users 261, 262, 263 may pay a fee to access the portal 180 to access the data 213 associated with the user 221 of Generation 1, for example. In this example, the user 221 from Generation 1 pays an initial fee to open a user account to store his digital assets as data 213 on storage device(s) 211. This initial fee may provide the user 221 the ability to create, transmit, and curate his own digital assets. This initial fee may allow the user 221 to store and access the digital assets for an initial time period (e.g., one month, one year). Upon expiration of the initial time period, the user 221 may then need to pay a renewal fee for continued storage and access to the digital assets for a renewal time period (e.g., one month, one year). This cycle may periodically continue until the user 221 closes his user account, stops paying renewal fees, and/or becomes deceased, for example. For example, the user 221 may renew his user account for 12 years by paying 12 yearly renewal fees.

The users 241, 242 from Generation 2 may also desire to access the digital assets stored as data 213 on the storage device(s) 211 via the portal 280. The users 241, 242 from Generation 2 each pay an initial fee to open a user account to access the digital assets of user 221 from Generation 1. These initial fees may allow the users 241, 242 to access the digital assets for an initial time period (e.g., one month, one year). Upon expiration of the initial time period, the users 241, 242 may then each need to pay a renewal fee for continued access to the digital assets for a renewal time period (e.g., one month, one year). This cycle may periodically continue until the users 241, 242 closes their user accounts, stop paying renewal fees, and/or become deceased, for example. For example, the user 241 may renew his user account for 20 years by paying 20 yearly renewal fees, while user 242 may renew her account for 18 years by paying 18 yearly renewal fees.

The users 261, 262, 263 from Generation 3 may also desire to access the digital assets stored as data 213 on the storage device(s) 211 via the portal 280. The users 261, 262, 263 from Generation 3 each pay an initial fee to open a user account to access the digital assets of user 221 from Generation 1. These initial fees may allow the users 261, 262, 263 to access the digital assets for an initial time period (e.g., one month, one year). Upon expiration of the initial time period, the users 261, 262, 263 may then each need to pay a renewal fee for continued access to the digital assets for a renewal time period (e.g., one month, one year). This cycle may periodically continue until the users 261, 262, 263 closes their user accounts, stop paying renewal fees, and/or become deceased, for example. For example, the user 261 may renew his user account for 4 years by paying 4 yearly renewal fees, while user 262 may renew his account for 30 years by paying 30 yearly renewal fees and user 263 may renew her account for 26 years by paying 26 yearly renewal fees.

The initial fees, renewal fees, and other fees may be received and processed by a financial transaction system 281 operating in conjunction with portal 280. The financial transaction system 281 may generate invoices for all users with user accounts and transmit those invoices to the users for payment. When a user submits payment to portal 280, the financial transaction system 281 may receive the payment and process the payment. The financial transaction system 281 may include any system that processes financial transactions in any manner. This may include manual and/or automated processing transactions using a local currency (U.S. dollar) and/or a digital currency (e.g., bitcoin).

The owner and/or operator receives many different fees from the users of Generation 1, Generation 2, and Generation 3. In the example above, the owner and/or operator receives the following fees:
one initial fee and 12 renewal fees from Generation 1,
two initial fees and 38 renewal fees from Generation 2, and
three initial fees and 60 renewal fees from Generation 3.
   Therefore, some example generation to generation data storage and access systems may generate large and/or long lasting revenue streams.

In some examples, a verification system 282 may verify the identity of the first user 221 providing the data and the verification 282 may also verify that the user 221 is authentic. In some examples, this may be called “authentity.” In this manner, the system 200 may be able verify that the first user 221 is who he says he is. In some examples, the verification system 282 may verify the identity of a second user 242 requesting access to the data. In this manner, the system 200 may be able verify that the second user 242 is who she says she is. Similarly, the verification system 282 may verify that the financial transaction system 281 is interacting (e.g., sending invoices, receiving payments) with the appropriate and authenticated users. The verification system 282 may include machine-based and/or human-based identity verification. In some examples, the verification system 282 may include hardware devices such as trusted platform modules, smartcards, and/or biometric devices to authenticate users.

FIG. 3 is an example generation to generation data storage and access revenue model, in accordance with at least some embodiments of the present disclosure. Over time, several generations of users may pay fees for access to data associated with one or more of the users. For example, a Generation 1 user may pay an initial fee 321 to store and/or access data about a user, and the Generation 1 user may also pay several renewal fees 322 for continued access to the data. At some point in time, a Generation 2 user may desire access the data and may pay an initial fee 323 to store and/or access data about a user and may also pay several renewal fees 324 for continued access to the data. Similarly, a Generation 3 user may desire access the data and may pay an initial fee 325 to store and/or access data about a user and may also pay several renewal fees 326 for continued access to the data.

FIGS. 4-5 depict example generation to generation storage and access revenue models 400, 500 where only one user (i.e., a first user 420, 520 from Generation 1) stores data 429, 529, in accordance with at least some embodiments of the present disclosure. The revenue models 400, 500 of FIGS. 4-5 both depict multiple generations requesting access to digital assets. While three generations are depicted in FIGS. 4-5, the present disclosure contemplates that more than three generations may access digital assets and produce revenue.

FIG. 4 represents example generation to generation storage and access systems and methods over Generation 1, Generation, and Generation 3, where only one user (i.e., a first user 420 from Generation 1) stores data 429.

A first user 420 from Generation 1 may purchase access to a generation to generation storage and access system. This purchase may allow the first user 420 to create an account in which he may store his digital assets as data 429, and this purchase may include an initial fee 422 for access and/or storage of the digital assets 429 during an initial time period 421. At or near the end of the initial period 421, the first user 420 may elect to renew his access by paying a renewal fee 424 for access and/or storage during a renewal time period 423. At or near the end of the renewal period 423, the first user 420 may elect to again renew his access by paying a maintenance fee 426 for access and/or storage during a maintenance time period 425. The first user 420 may elect to continue receiving access by continuing to pay additional fees for each subsequent time period. In some examples, the first user 420 may elect to discontinue his access to the digital assets 429 by canceling his user account and/or stopping payment of fees.

Example time periods may include one year periods, one month periods, and one week periods, and one day periods. For discussion purposes, assume that FIGS. 4-5 have time periods of one year.

A second user 440 from Generation 2 may purchase access to a generation to generation storage and access system to access the first user's 420 digital assets 429. This purchase may allow the second user 440 to create an account in which she may access digital assets 429 of the first user 420, and this purchase may include an initial fee 442 for access to the digital assets 429 during an initial time period 441. At or near the end of the initial period 441, the second user 440 may elect to renew her access by paying a renewal fee 444 for access during a renewal time period 443. At or near the end of the renewal time period 443, the second user 440 may elect to again renew her access by paying a maintenance fee 446 for access during a maintenance time period 445. The second user 440 may elect to continue receiving access by continuing to pay additional fees for each subsequent time period. In some examples, the second user 440 may elect to discontinue her access to the digital assets 429 by canceling her user account and/or stopping payment of fees.

A third user 460 from Generation 3 may purchase access to a generation to generation storage and access system to access first user's 420 digital assets 429. This purchase may allow the third user 460 to create an account in which he may access digital assets 429 of the first user 420, and this purchase may include an initial fee 462 for access to the digital assets 429 during an initial time period 461. At or near the end of the initial period 461, the third user 460 may elect to renew his access by paying a renewal fee 464 for access during a renewal time period 463. At or near the end of the renewal time period 463, the third user 460 may elect to again renew his access by paying a maintenance fee 466 for access during a maintenance time period 465. The third user 460 may elect to continue receiving access by continuing to pay additional fees for each subsequent time period. In some examples, the third user 460 may elect to discontinue his access to the digital assets 429 by canceling his user account and/or stopping payment of fees.

In some examples, the first user 420, the second user 440, and the third user 460 may be in multiple generation-to-generation systems simultaneously. For example, the third user 460 may participate as a Generation 3 user (as described with reference to FIG. 6), and may simultaneously participate as a Generation 1 user in separate generation-to-generation systems. For example, the third user 460 may be a Generation 3 user in a familial generation-to-generation system while also being a Generation 1 user in a corporate generation-to-generation system. This may require payment of fees in both generation-to-generation systems. Similarly, the third user 460 may be deemed a Generation 3 user (as described with reference to FIG. 6) and a also a Generation 1 user (in the event that users in future generations pay to access the third user's 460 data) in the same generation-to-generation system.

In some examples, the first user 420, the second user 440, and the third user 460 may all have access to digital assets at the same time. For this to occur, this means that all three users are concurrently paying fees to access the digital assets. In other words, time periods (either initial, renewal, and/or maintenance time periods) of each of the users are overlapping. For example, the first user 420 may be in his maintenance period 425 (after paying his maintenance fee 426) at the same time the second user 440 is in her renewal period 443 (after paying her renewal fee 444) and at the same time the third user 460 may be in his initial period 461 (after paying his initial fee 462).

In some examples, multiple users may be in their same time period. For example, While the first user 420 may be in his renewal period 423, both the second user 440 and the third user 460 may be in their respective initial periods 441 and 461.

In some examples, the first user 420, the second user 440, and the third user 460 may not all have access to digital assets at the same time. For example, the second user 440 may decide to discontinue paying for access to the digital assets, while the first user 420 and the third user 460 elect to continue paying their fees to access the digital assets. In some examples, if all users discontinue paying for access, the digital assets 429 may be deleted from the system. In some examples, the digital assets 429 may continue to be stored in the system and may be accessed again upon payment of a reactivation fee by a user.

FIG. 5 represents example generation to generation storage and access systems and methods over Generation 1, Generation, and Generation 3, where only one user (i.e., first user 520 from Generation 1) stores data 529. FIG. 5 includes example fee payment required for access to the data 529 by each of a first user 520 from Generation 1, a second user 540 from Generation 2, and a third user 560 from Generation 3. While specific dollar amounts are associated with initial, renewal, and maintenance fees in FIG. 5, the present disclosure contemplates that other dollar amounts may be charged for these respective fees in accordance with the disclosures herein.

The first user 520 from Generation 1 may purchase access to a generation to generation storage and access system during an initial time period 521 by paying an initial fee 522 of $21. At or near the end of the initial period 521, the first user 520 may elect to renew his access by paying a renewal fee 524 of $7 (which is less than the initial fee 521) for access and/or storage during a renewal time period 523. At or near the end of the renewal period 523, the first user 520 may elect to again renew his access by paying a maintenance fee 526 of $3 (which is less than the renewal fee 523) for access and/or storage during a maintenance time period 525. The first user 520 may elect to continue receiving access by continuing to pay additional fees for each subsequent time period. In some examples, each subsequent time period may require a payment equal to the maintenance fee 526, which is $3 in this example.

The second user 540 from Generation 2 may purchase access to a generation to generation storage and access system during an initial time period 541 by paying an initial fee 542 of $7 (which is equal to the renewal fee 524 of first user 520). This allows access to the data 529 of the first user 520. At or near the end of the initial period 541, the second user 540 may elect to renew her access by paying a renewal fee 524 of $7 (which is equal to the initial fee 542) for access during a renewal time period 543. At or near the end of the renewal period 543, the second user 540 may elect to again renew her access by paying a maintenance fee 546 of $7 (which is equal to the renewal fee 544) for access during a maintenance time period 545. The second user 540 may elect to continue receiving access by continuing to pay additional fees for each subsequent time period. In some examples, each subsequent time period may require a payment equal to the maintenance fee 546, which is $7 in this example.

The third user 560 from Generation 3 may purchase access to a generation to generation storage and access system during an initial time period 561 by paying an initial fee 562 of $1 (which is less than the initial fee 542 of second user 540). This allows access to the data 529 of the first user 520. At or near the end of the initial period 561, the third user 560 may elect to renew his access by paying a renewal fee 564 of $1 (which is equal to the initial fee 562) for access during a renewal time period 563. At or near the end of the renewal period 563, the third user 560 may elect to again renew his access by paying a maintenance fee 566 of $1 (which is equal to the renewal fee 564) for access during a maintenance time period 565. The third user 560 may elect to continue receiving access by continuing to pay additional fees for each subsequent time period. In some examples, each subsequent time period may require a payment equal to the maintenance fee 566, which is $1 in this example.

FIGS. 6-7 depict example generation to generation storage and access revenue models 600, 700, where three users (i.e., first user 620, 720 from Generation 1, a second user 640, 740 from Generation 2, and a third user 660, 760 from Generation 3) store data, in accordance with at least some embodiments of the present disclosure. The revenue models 600, 700 of FIGS. 6-7 both depict multiple generations requesting access to digital assets. While three generations are depicted in FIGS. 6-7, the present disclosure contemplates that more than three generations may store and access digital assets and produce revenue.

FIG. 6 represents example generation to generation storage and access systems and methods over Generation 1, Generation, and Generation 3, where three users (i.e., first user 620 from Generation 1, a second user 640 from Generation 2, and a third user 660 from Generation 3) store respective data 629, 649, 669.

A first user 620 from Generation 1 may purchase access to a generation to generation storage and access system. This purchase may allow the first user 620 to create an account in which he may store his digital assets as data 629, and this purchase may include an initial fee 622 for access and/or storage of the digital assets 629 during an initial time period 621. At or near the end of the initial period 621, the first user 620 may elect to renew his access by paying a renewal fee 624 for access and/or storage during a renewal time period 623. At or near the end of the renewal period 623, the first user 620 may elect to again renew his access by paying a maintenance fee 626 for access and/or storage during a maintenance time period 625. The first user 620 may elect to continue receiving access by continuing to pay additional fees for each subsequent time period. In some examples, the first user 620 may elect to discontinue his access to the digital assets 629 by canceling his user account and/or stopping payment of fees.

A second user 640 from Generation 2 may purchase access to a generation to generation storage and access system to access the first user's 620 digital assets 629 and also store and access her own digital assets 649. This purchase may allow the second user 640 to create an account in which she may access the digital assets 629 of the first user 620 and may also store her own digital assets as data 649. This purchase may include an initial fee 642, a portion of which may be for storage of and access to her own digital assets 649 during an initial time period 641 and a portion of which may be for access to the digital assets 629 of the first user 620 during an initial time period 641.

At or near the end of the initial period 641, the second user 640 may elect to renew her account by paying a renewal fee 644 for access and/or storage during a renewal time period 643. This renewal fee 644 may include a portion for storage of and access to her own digital assets 649 during the renewal time period 643 and a portion for access to the digital assets 629 of the first user 620 during the renewal time period 643.

At or near the end of the renewal time period 643, the second user 640 may elect to again renew her account by paying a maintenance fee 646 for access and/or storage during a maintenance time period 645. This maintenance fee 646 may include a portion for storage of and access to her own digital assets 649 during the maintenance time period 645 and a portion of which may be for access to the digital assets 629 of the first user 620 during the maintenance time period 645. The second user 640 may elect to continue receiving access by continuing to pay additional fees for each subsequent time period. In some examples, the second user 640 may elect to discontinue her access to the digital assets by canceling her account and/or stopping payment of fees.

A third user 660 from Generation 3 may purchase access to a generation to generation storage and access system to access the first user's 620 digital assets 629 and the second user's 640 digital assets 649, and also store and access his own digital assets 649. This purchase may allow the third user 660 to create an account in which he may access the digital assets 629 of the first user 620 and the digital assets 649 of the second user 640, and may also store his own digital assets as data 669. This purchase may include an initial fee 662, a portion of which may be for storage of and access to his own digital assets 669 during an initial time period 661, a portion of which may be for access to the digital assets 629 of the first user 620 during an initial time period 661, and a portion of which may be for access to the digital assets 649 of the second user 640 during an initial time period 661.

At or near the end of the initial period 661, the third user 660 may elect to renew his account by paying a renewal fee 664 for access and/or storage during a renewal time period 663. This renewal fee 664 may include a portion for storage of and access to his own digital assets 669 during the renewal time period 663, a portion for access to the digital assets 629 of the first user 620 during the renewal time period 663, and a portion for access to the digital assets 649 of the second user 640 during the renewal time period 663.

At or near the end of the renewal time period 663, the third user 660 may elect to again renew his account by paying a maintenance fee 666 for access and/or storage during a maintenance time period 665. This maintenance fee 666 may include a portion for storage of and access to his own digital assets 669 during the maintenance time period 665, a portion for access to the digital assets 629 of the first user 620 during the maintenance time period 665, and a portion for access to the digital assets 649 of the second user 640 during the maintenance time period 665. The third user 660 may elect to continue receiving access by continuing to pay additional fees for each subsequent time period. In some examples, the third user 660 may elect to discontinue his access to the digital assets by canceling his account and/or stopping payment of fees.

FIG. 7 represents example generation to generation storage and access systems and methods over Generation 1, Generation, and Generation 3, where three users (i.e., first user 720 from Generation 1, second user 740 from Generation 2, and third user 760 from Generation 3) store respective data 729, 749, 769. FIG. 7 includes example fee payment required for access for each of a first user 720 from Generation 1, a second user 740 from Generation 2, and a third user 760 from Generation 3. While specific dollar amounts are associated with initial, renewal, and maintenance fees in FIG. 7, the present disclosure contemplates that other dollar amounts may be charged for these respective fees in accordance with the disclosures herein.

The first user 720 from Generation 1 may purchase access to a generation to generation storage and access system during an initial time period 721 by paying an initial fee 722 of $21.

At or near the end of the initial period 721, the first user 720 may elect to renew his access by paying a renewal fee 724 of $7 for access and storage during a renewal time period 723. In some examples, the renewal fee 724 is less than the initial fee 722. In some examples, the renewal fee 724 is greater than the initial fee 722.

At or near the end of the renewal period 723, the first user 720 may elect to again renew his access by paying a maintenance fee 726 of $3 for access and/or storage during a maintenance time period 725. In some examples, the maintenance fee 726 is less than the renewal fee 724. In some examples, the maintenance fee 726 is greater than the renewal fee 724. The first user 720 may elect to continue receiving access by continuing to pay additional fees for each subsequent time period. In some examples, each subsequent time period may require a payment equal to the maintenance fee 726.

The second user 740 from Generation 2 may purchase access to a generation to generation storage and access system during an initial time period 741 by paying an initial fee 742 of $28 (which includes $21 for storage and access to her own digital assets 749 and $7 for access to the digital assets 729 of the first user 720).

At or near the end of the initial period 741, the second user 740 may elect to renew her access during a renewal time period 743 by paying a renewal fee 744 of $14 (which includes $7 for storage and access to her own digital assets 749 and $7 for access to the digital assets 729 of the first user 720). In some examples, the renewal fee 744 is less than the initial fee 742, while in some examples, the renewal fee 744 is greater than the initial fee 742.

At or near the end of the renewal period 743, the second user 740 may elect to again renew her access during a maintenance time period 745 by paying a maintenance fee 746 of $10 (which includes $3 for storage and access to her own digital assets 749 and $7 for access to the digital assets 729 of the first user 720). In some examples, the maintenance fee 746 is less than the renewal fee 744. In some examples, the maintenance fee 746 is greater than the renewal fee 744. The second user 740 may elect to continue receiving access by continuing to pay additional fees for each subsequent time period. In some examples, each subsequent time period may require a payment equal to the maintenance fee 746.

The third user 760 from Generation 3 may purchase access to a generation to generation storage and access system during an initial time period 761 by paying an initial fee 762 of $29 (which includes $21 for storage and access to his own digital assets 769, $7 for access to the digital assets 749 of the second user 740, and $1 for access to the digital assets 729 of the first user 720).

At or near the end of the initial period 761, the third user 760 may elect to renew his access during a renewal time period 763 by paying a renewal fee 764 of $15 (which includes $7 for storage and access to his own digital assets 749, $7 for access to the digital assets 749 of the second user 740, and $1 for access to the digital assets 729 of the first user 720). In some examples, the renewal fee 764 is less than the initial fee 762, while in some examples, the renewal fee 764 is greater than the initial fee 762.

At or near the end of the renewal period 763, the third user 760 may elect to again renew his access during a maintenance time period 765 by paying a maintenance fee 766 of $11 (which includes $3 for storage and access to his own digital assets 769, $7 for access to the digital assets 749 of the second user 740, and $1 for access to the digital assets 729 of the first user 720). In some examples, the maintenance fee 766 is less than the renewal fee 764. In some examples, the maintenance fee 766 is greater than the renewal fee 764. The third user 760 may elect to continue receiving access by continuing to pay additional fees for each subsequent time period. In some examples, each subsequent time period may require a payment equal to the maintenance fee 766.

FIGS. 8-10 depict example generation to generation storage and access revenue models, in accordance with at least some of the embodiments disclosed in the present disclosure. FIGS. 8-10 show how generation to generation storage and access systems may quickly produce revenue growth (e.g., exponential growth) over several generations.

FIGS. 8-9 depict models 800, 900 in which many generations of humans in a family pay to access digital and biological data. In these examples, multiple users in Generation 1 may generate revenue by paying fees to access the digital and biological data. Similarly, multiple users in the following generations (i.e., Generations 2 through n) may each have an increasing number of users generating revenue through fee payments for access to the digital and biological data.

FIG. 10 depicts a model 100 in which many generations of corporate entities pay to access corporate data. In these examples, multiple users in Generation 1 may generate revenue by paying fees to access the corporate data. Similarly, multiple users in the following generations (i.e., Generations 2 through n) may each have an increasing number of users generating revenue through fee payments for access to the corporate data.

In some examples, data may be aggregated and portions of the aggregated data may be sold, licensed, or otherwise transferred to a third party. For example, many users may store information related to purchases of a vehicle. Such information, in addition to anonymous demographic data about each user, may be compiled and sold to a company that sells vehicles. The vehicle company may pay to access and mine this data. In this manner, the users may receive an incentive such as a portion of the sales, license, or transfer fees, and the third party vehicle company may receive relevant sales and marketing data. In some examples, the data may simply include high-level demographic information, while in some examples, detailed user and transaction data may be included. In some examples, the generation-to-generation system may act as a middleman or agent to the users to negotiate transactions involving the users' data on the users' behalf.

In some examples, a generation-to-generation data storage and access system may act on behalf of its users (i.e., people or entities that store and/or access data) to negotiate deals or transactions between the users (and related future generations) and a third party. This may be viewed as a type of “digital union” of which the users are members and the generation-to-generation data storage and access system is a representative of the union. In this manner, the generation-to-generation data storage and access system may arrange and negotiate terms of transactions between the users and a third party with a focus on the best interests of the users and future generations associated with the users. Therefore, the generation-to-generation data storage and access system may provide negotiating power for an entire class users and/or an entire generation.

Some examples generation-to-generation data storage and access systems may negotiate with a third party company to obtain compensation (e.g., payment) for access to the users' data by the third party. The third party may access and/or use the data for many reasons, including market analysis, customer profiling, sales projections, sales strategies, and the like. The users' data may include, for example, an individual user's data, data about a group of users, data about an entire generational class (e.g., one or more of Generation 1 through Generation n of a family, one or more of Generation 1 through Generation n of a corporation), and/or aggregated data for all users, which may be anonymized or may be actual data stored by a group of users. Compensation may include money in the form of royalty payments, micropayments, license fee payments, and the like.

This compensation may be accessed and/or transferred to future generations such that the future generations continue to receive the compensation after the original user fails to exist. For example, if Bob is a Generation 1 user that stores his data (e.g., images) on a generation-to-generation data storage and access system, Bob may allow the generation-to-generation data storage and access system to negotiate a transaction with a third party company. This transaction may provide access to Bob's data to the third party company for use in marketing materials. Bob's data may be accessed and/or used by the third party company in exchange for compensation in the form of monthly micropayments. In the event of Bob's death, the monthly micropayments may be transferred to Bob's daughter (a Generation 2 user that pays a fee to access Bob's data). These micropayments may continue as long as the transaction terms contemplate, and may continue for many generations after Bob's daughter dies.

In another example, consider a soldier. This soldier may control a user account on a social network platform. The soldier may accumulate many data items that may be stored and/or associated with his user account on the social network. Conventionally, if the soldier were to die during a war, the soldier's family would not be permitted access to the soldier's data stored on the social network. This is typical of EULAs for social networks. The present disclosure contemplates that a generation-to-generation data storage and access systems may give the users such as the soldier greater negotiating leverage to change the terms of conventional EULAs to provide access to the soldier's data to the soldier's family in the event of the soldier's death. In some examples, the generation-to-generation data storage and access system would negotiate better EULA terms for all users of the generation-to-generation data storage and access system.

A mathematical example of a generation-to-generation model including a plurality of human users follows:

A person x₁ is a first user when x₁ inputs certain data, denoted d₁, at time t₁ into a storage device for an initial fee (denoted F₁) for a period (denoted p₁), where F₁ is a function of x₁, t₁, p₁ and d₁ (i.e., F₁ (x₁, t₁, p₁, d₁)). First user transactions may be renewed where the renewal fee, denoted R₁(x₁, t₁, p₁, d₁), is less than F₁.

A person x₂ is a second user with respect to a first user transaction by x₁ when x₂ pays an initial fee, which is a function of x₁, t₁, p₁, d₁ and denoted here as F₂(F₁, x₁, p₁, t₁, d₁) for access to x₁'s data, d₁, for a period equal to p₁. In addition, F₂<F₁, i.e., x₂'s initial fee is less than x₁'s initial fee.

In general, a person xᵢ is an i^{th} user with respect to a first user transaction by x₁ when xᵢ pays an initial fee, which is a function of x₁, t₁, p₁, d₁ and denoted here as Fᵢ(F₁, x₁, t₁, p₁, d₁) for access to x₁'s data, d₁. In addition, the initial fees of i^{th} users are such that Fᵢ<Fᵢ₋₁, i>1, but where i^{th} person renewal fees are such that Rᵢ<F_{i.}

In general, an i^{th} user with respect to a first user transaction may comprise a plurality of i^{th} users, wherein receiving the i^{th} user initial fee from the second user comprises receiving the i^{th} user initial fee from each of the plurality of second users; and wherein receiving the i^{th} user renewal fee from the i^{th} user comprises receiving i^{th} user renewal fee from each of the plurality of i^{th} users.

Note that a second user with respect to a first user transaction may initiate a first user transaction with respect to his or her own data. More generally, an i^{th} user may initiate a first user transaction with respect to xᵢ's own data.

In some examples, example computing devices may include a computer, the computer including a processing unit, a system memory and a system bus. The system bus may couple system components including, but not limited to, the system memory to the processing unit. The processing unit may be any of various commercially available processors. Dual microprocessors and other multi-processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory includes read only memory (ROM) and random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis (not shown), a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of an example system.

A number of program modules may be stored in the drives and RAM, including an operating system, one or more application programs, other program modules and program data. All or portions of the operating system, applications, modules, and/or data may also be cached in the RAM. It is appreciated that an example system may be implemented with various commercially available operating systems or combinations of operating systems.

A user may enter commands and information into the computer through one or more wired/wireless input devices, e.g., a keyboard and a pointing device, such as a mouse. Other input devices (not shown) may include a microphone, an IR remote control, a joystick, a game pad, a stylus pen, touch screen, or the like. These and other input devices are often connected to the processing unit through an input device interface that is coupled to the system bus, but may be connected by other interfaces, such as a parallel port, an IEEE 1394 serial port, a USB port, an IR interface, etc. To limit access to authenticated users, trusted platform modules, smartcards, biometric devices, etc. may be used. In some examples, a user interface catcher may that enable a user to opt-in to the collection of activity information while the user operates a computing device.

A monitor or other type of display device is also be connected to the system bus via an interface, such as a video adapter. In addition to the monitor, a computer typically includes other peripheral output devices (not shown), such as speakers, printers, etc.

The computer may operate in a networked environment using logical connections via wired and/or wireless communications to one or more remote computers, such as a remote computer(s). The remote computer(s) may be a workstation, a server computer, a router, a personal computer, portable computer, microprocessor-based entertainment appliance, a peer device or other common network node, and typically includes many or all of the elements described relative to the computer, although, for purposes of brevity, only a memory storage device is illustrated. The logical connections depicted include wired/wireless connectivity to a local area network (LAN) and/or larger networks, e.g., a wide area network (WAN). Such LAN and WAN networking environments are commonplace in offices, and companies, and facilitate enterprise-wide computer networks, such as intranets, all of which may connect to a global communication network, e.g., the Internet.

When used in a LAN networking environment, the computer may be connected to the local network through a wired and/or wireless communication network interface or adapter. The adaptor may facilitate wired or wireless communication to the LAN, which may also include a wireless access point disposed thereon for communicating with the wireless adaptor.

When used in a WAN networking environment, the computer may include a modem, or is connected to a communications server on the WAN, or has other means for establishing communications over the WAN, such as by way of the Internet. The modem, which may be internal or external and a wired or wireless device, is connected to the system bus via the serial port interface. In a networked environment, program modules depicted relative to the computer, or portions thereof, may be stored in the remote memory/storage device. It will be appreciated that the network connections shown are exemplary and other means of establishing a communications link between the computers may be used.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth wireless technologies. Thus, the communication may be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network may be used to connect computers to each other, to the Internet, and to wired networks (which use IEEE 802.3 or Ethernet). Wi-Fi networks operate in the unlicensed 2.4 and 5 GHz radio bands, including 802.11a-n, for example, or with products that contain both bands (dual band), so the networks may provide real-world performance similar to the basic 10BaseT wired Ethernet networks used in many offices.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method, comprising:
storing data associated with a first user in one or more storage devices;
receiving a first user initial fee from the first user, the first user initial fee being associated with providing access to the data by the first user during a first user initial period;
after the first user initial period, receiving a first user renewal fee from the first user, the first user renewal fee being associated with providing access to the data by the first user during a first user renewal period, the first user renewal fee being less than the first user initial fee;
receiving a second user initial fee from a second user, the second user initial fee being associated with providing access to the data by the second user during a second user initial period, the second user renewal fee being equal to the first user renewal fee; and
after the second user initial period, receiving a second user renewal fee from the second user, the second user renewal fee being associated with providing access to the data by the second user during a second user renewal period, the second user renewal fee being equal to the second user initial fee.

2. The method of claim 1, further comprising:
receiving a third user initial fee from a third user, the a third user initial fee being associated with providing access to the data by the third user during a third user initial period; and
after the third user initial period, receiving a third user renewal fee from the third user, the third user renewal fee being associated with providing access to the data by the third user during a third user renewal period, the third user renewal fee being less than the third user initial fee.

3. The method of claim 1,
wherein the first user is from a first familial generation of a family; and
wherein the second user is from a second familial generation of the family.

4. The method of claim 2,
wherein the first user is from a first familial generation of a family;
wherein the second user is from a second familial generation of the family; and
wherein the third user is from a third familial generation of the family.

5. The method of claim 1,
wherein the data comprises data associated with the first user and data associated with the second user;
wherein the second user initial fee is associated with storing the data and providing access to the data by the second user during the second user initial period, the second user initial fee being greater than the first user initial fee; and
wherein the second user renewal fee is associated with storing the data and providing access to the data by the second user during the second user renewal period, the second user renewal fee being greater than the first user renewal fee.

6. The method of claim 1,
wherein the first user is a first entity; and
wherein the second user is a second entity has a legal relationship with the first entity.

7. The method of claim 1,
wherein the second user comprises a plurality of second users,
wherein receiving the second user initial fee from the second user comprises receiving the second user initial fee from each of the plurality of second users; and
wherein receiving the second user renewal fee from the second user comprises receiving the second user renewal fee from each of the plurality of second users.

8. The method of claim 2,
wherein the third user comprises a plurality of third users,
wherein receiving the third user initial fee from the third user comprises receiving the third user initial fee from each of the plurality of third users; and
wherein receiving the third user renewal fee from the third user comprises receiving the third user renewal fee from each of the plurality of third users.

9. A method, comprising:
generating a first initial invoice for the member of a first generation, the first initial invoice including a first initial fee for storing data about a member of the first generation in one or more storage device during a first initial time period;
generating a first renewal invoice for the member of the first generation, the first renewal invoice including a first renewal fee for accessing the data during a first renewal time period, the first renewal fee being less than the first initial fee;
generating a second initial invoice for a member of a second generation, the second initial invoice including a second initial fee for accessing the data during a second initial time period, the second initial fee being equal to the first renewal fee; and
generating a second renewal invoice for the member of the second generation, the second renewal invoice including a second renewal fee for accessing the data during a second renewal time period, the second renewal fee being equal to the first renewal fee.

10. The method of claim 9, further comprising:
generating a third initial invoice for a member of a third generation, the third initial invoice including a third initial fee for accessing the data during a third initial time period, the third initial fee being less than the second initial fee; and
generating a third renewal invoice for the member of the third generation, the third renewal invoice including a third renewal fee for accessing the data during a third renewal time period, the third renewal fee being less than to the second renewal fee.

11. The method of claim 9, wherein the first renewal fee for accessing the data during the first renewal time period is equal to the first initial fee for accessing the data during the first initial time period.

12. The method of claim 9, wherein the second renewal fee for accessing the data during the second renewal time period is equal to the second initial fee for accessing the data during the second initial time period.

13. The method of claim 10, further comprising:
negotiating with a third party a transaction on behalf of the member of the first generation;
providing access to the data about a member of the first generation to the third party;
receiving compensation from the third party in exchange for access to the data; and
paying at least a portion of the compensation to the member of the first generation.

14. A method, comprising:
requesting, via a computing device, access to data stored on a server device, the data being associated with a first user and being stored upon a request by the first user;
paying an initial payment to a third party for access during an initial time period to the data stored on the server device; and
paying a renewal payment to the third party for access during a renewal time period to the data stored on the server device, the renewal payment being less than the initial payment.

15. The method of claim 14, further comprising:
paying a maintenance payment to the third party for access during a maintenance time period to the data stored on the server device, the maintenance payment being the same as the renewal payment.

16. The method of claim 14, wherein the renewal time period begins immediately after the initial time period ends.

17. A system, comprising:
at least one storage device configured to store data about a first user;
a verification system configured to verify an identity of the first user providing the data about the first user and further configured to verify an identity of a second user requesting access to the data; and
a financial transaction system configured to process a plurality of payments from at least the first user and the second user, the plurality of payments including at least:
a first user initial fee;
a first user renewal fee that is less than the first user initial fee;
a second user initial fee for access to the data about the first user; and
a second user renewal for access to the data about the first user, the second user renewal fee being the same as the first user renewal fee; and

18. The system of claim 17,
wherein the data about the first user is made accessible to the first user during a first user initial period after the financial transaction system receives the first user initial fee; and
wherein the data about the first user is made accessible to the first user during a first user renewal period after the financial transaction system receives the first user renewal fee.

19. The system of claim 17,
wherein the data about the first user is made accessible to the second user during a second user initial period after the financial transaction system receives the second user initial fee; and
wherein the data about the first user is made accessible to the second user during a second user renewal period after the financial transaction system receives the second user renewal fee.

20. The system of claim 17, wherein the financial transaction system is further configured to receive at least one of:
a first user maintenance fee that is less than the first user renewal fee; and
a second user maintenance fee that is the same as the second user renewal fee.
